(19) United States
(12) Patent Application Publication
(10) Pub. No.: US 2025/0103318 A1
(43) Pub. Date: Mar. 27, 2025

(54) DONGLE DEVICE AND FIRMWARE UPDATING METHOD THEREOF

(71) Applicant: REALTEK SEMICONDUCTOR CORP., Hsinchu (TW)

(72) Inventors: Chih-Hsiang Shen, Hsinchu (TW); Si-Xian Wang, Suzhou (CN); Yu Meng, Suzhou (CN); Yi-Song Yin, Suzhou (CN)

(73) Assignee: REALTEK SEMICONDUCTOR CORP., Hsinchu (TW)

(21) Appl. No.: 18/774,582

(22) Filed: Jul. 16, 2024

(30) Foreign Application Priority Data
Sep. 25, 2023 (CN) 202311242908.9

(51) Int. Cl. G06F 8/65; H04L 67/00; H04W 76/11

(52) U.S. Cl. CPC G06F 8/65; H04L 67/34; H04W 76/11

(57) ABSTRACT

A dongle device and a firmware updating method are provided. The dongle device includes a connector, a communication module, a storage module, and a control module. The storage module is configured to store a device ID and a first image file. The control module is electrically connected to the connector, the communication module, and the storage module. The control module is configured to output an updating command to an electronic device through the connector, control the communication module to scan and to wirelessly receive a broadcast packet broadcasted by the electronic device, control the communication module to establish a wireless connection between the dongle device and the electronic device according to the broadcast packet, and use the first image file to update a firmware of the electronic device via the wireless connection. The updating command and the broadcast packet have the same device ID.

### CROSS-REFERENCE TO RELATED APPLICATION

This non-provisional application claims priority under 35 U.S.C. § 119 (a) to patent application No. 202311242908.9 filed in China, P.R.C. on Sep. 25, 2023, the entire contents of which are hereby incorporated by reference.

### BACKGROUND

### Technical Field

The present disclosure relates to firmware updating technologies, and particularly relates to a dongle device and a firmware updating method thereof.

### Related Art

Currently, methods for updating software of electronic products on production lines include Phone OTA (On-The-Air) tools and Windows OTA tools. As to the Phone OTA tools on the production lines, manual interventions have to be applied. As a result, as for the application of the Phone OTA tools, automated update of the software of the electronic products cannot be achieved easily in a batch-wise manner. In comparison, the Windows OTA tools rely more on PCs of the production line and the configuration of the environment of the PCs. However, if the software of the electronic products in a batch-wise manner is to be updated by using the Windows OTA tools, a problem of wireless misconnection may occur to the Windows OTA tools, thereby affecting the work efficiency of the production lines.

### SUMMARY

In order to address the problem(s) mentioned above, the present disclosure provides a dongle device and a firmware updating method to store a firmware image file corresponding to a firmware of an electronic device in the dongle device. According to one or some embodiments, the dongle device can work with or without a PC to provide an offline updating function (in the case that the dongle device is not connected to the PC) or an online updating function (in the case that the dongle device is connected to the PC to obtain information additionally and dynamically upon the software is updating). An only ID exists between the dongle device and the electronic device, and the only ID is configured to prevent multiple sets of electronic devices from having mutual interference when the multiple sets of electronic devices update the software.

In one or some embodiments, the firmware updating method comprises: establishing a wired connection between the dongle device and an electronic device; outputting an updating command to the electronic device via the wired connection, and the updating command has a device ID of the dongle device; scanning and wirelessly receiving a broadcast packet broadcasted by the electronic device, and the broadcast packet has the device ID; establishing a wireless connection between the dongle device and the electronic device according to the broadcast packet; and using a first image file to update a firmware of the electronic device via the wireless connection, and the first image file is stored in a storage module of the dongle device.

In some embodiments, the firmware updating method further comprises: displaying an execution result of updating the firmware of the electronic device.

In some embodiments, the firmware updating method further comprising: sending an ending command to the electronic device to turn off the power of the electronic device via the wireless connection after the step of updating the firmware of the electronic device.

In some embodiments, the firmware updating method further comprises: establishing another wired connection between the dongle device and an external host; receiving the first image file sent from the external host via the another wired connection; and storing the first image file sent from the external host.

In some embodiments, the firmware updating method further comprises: receiving an activating command sent from the external host via the another wired connection after the step of receiving the first image file, and the step of outputting the updating command is executed in response to the activating command.

In some embodiments, the firmware updating method further comprises: outputting the execution result of updating the firmware of the electronic device to the external host via the another wired connection after the step of updating the firmware of the electronic device.

In some embodiments, the firmware updating method further comprises: receiving a second image file sent from the external host via the another wired connection; and using the second image file to update a firmware of the dongle device.

In some embodiments, the step of outputting the updating command via the wired connection is executed in response to an updating trigger event of at least one button of the dongle device.

In some embodiments, a dongle device comprises a connector, a communication module, a storage module, and a control module. The storage module is configured to store a device ID and a first image file. The control module is electrically connected to the connector, the communication module, and the storage module. The control module is configured to output an updating command to an electronic device through the connector, the control module is configured to control the communication module to scan and to wirelessly receive a broadcast packet broadcasted by the electronic device, the control module is configured to control the communication module to establish a wireless connection between the dongle device and the electronic device according to the broadcast packet, and the control module is configured to use the first image file to update a firmware of the electronic device via the wireless connection. The updating command and the broadcast packet have the same device ID.

In some embodiments, the dongle device further comprises a display module. The display module is electrically connected to the control module, and the display module is configured to display an execution result of updating the firmware of the electronic device.

In some embodiments, the dongle device further comprises a housing and at least one button. The connector, the display module, and the at least one button are embedded on the housing, the communication module, the storage module, and the control module are disposed in the housing, and the control module is further configured to boot the dongle device in response to a boot trigger event of the at least one button.

In some embodiments, the control module is further configured to output the updating command to the electronic device through the connector in response to an updating trigger event of the at least one button.

In some embodiments, the dongle device further comprises another connector. The another connector is configured to establish another wired connection between the dongle device and an external host, and the control module is further configured to receive the first image file sent from the external host through the another connector and store the first image file in the storage module.

In some embodiments, the control module is further configured to receive an activating command sent from the external host through the another connector, and the control module outputs the updating command to the electronic device through the connector in response to the activating command.

In some embodiments, the control module is further configured to output the execution result of updating the firmware of the electronic device to the external host through the another connector.

In some embodiments, the control module is further configured to receive a second image file sent from the external host through the another connector and use the second image file to update a firmware of the dongle device.

In some embodiments, the connector is configured to establish a wired connection between the dongle device and the electronic device, the connector is configured to establish another wired connection between the dongle device and an external host, the control module is further configured to receive the first image file sent from the external host through the connector when the connector is connected to the external host and store the first image file in the storage module, and the control module outputs the updating command to the electronic device through the connector when the connector is connected to the electronic device.

In conclusion, according to one or some embodiments, a user can download the firmware image file of the electronic device from the external host to the dongle device in advance, so that the dongle device and the firmware updating method can support both the offline updating function and the online updating function. Therefore, the user can update the firmware of the electronic device through the dongle device in the manner of offline updating or online updating so as to improve the convenience of updating the firmware of the electronic device.

### BRIEF DESCRIPTION OF DRAWINGS

The instant disclosure will become more fully understood from the detailed description given herein below for illustration only, and therefore not limitative of the instant disclosure, wherein:

FIG. 1 illustrates a module block diagram of a dongle device according to one or some embodiments of the present disclosure;

FIG. 2 illustrates a schematic top plan view of a first embodiment of the dongle device shown in FIG. 1;

FIG. 3 illustrates a schematic perspective view of the first embodiment of the dongle device shown in FIG. 2;

FIG. 4 illustrates a flow chart showing operations of an exemplary embodiment of the dongle device shown in FIG. 1;

FIG. 5 illustrates a schematic top plan view of an embodiment of the dongle device shown in FIG. 2 and an electronic device;

FIG. 6 illustrates a flow chart showing operations of a first embodiment following after the step S140 shown in FIG. 4;

FIG. 7 illustrates a schematic view of an implementation of the dongle device shown in FIG. 5 after the dongle device is processed via the step S150 shown in FIG. 6;

FIG. 8 illustrates a flow chart showing operations of a second embodiment following after the step S140 shown in FIG. 4;

FIG. 9 illustrates a flow chart showing operations of an embodiment followed before the step S100 shown in FIG. 4;

FIG. 10 illustrates a schematic top plan view of an embodiment of the dongle device shown in FIG. 2 and an external device;

FIG. 11 illustrates a schematic perspective view of a second embodiment of the dongle device shown in FIG. 1;

FIG. 12 illustrates a schematic top plan view of the second embodiment of the dongle device shown in FIG. 1;

FIG. 13 illustrates a schematic perspective view of an embodiment of the dongle device shown in FIG. 12;

FIG. 14 illustrates a schematic top plan view of an embodiment of the dongle device shown in FIG. 1, an electronic device, and an external host;

FIG. 15 illustrates a flow chart showing operations of a third embodiment following after the step S140 shown in FIG. 4;

FIG. 16 illustrates a flow chart showing operations of an embodiment following after the step S70 shown in FIG. 9;

FIG. 17 illustrates a flow chart showing operations of an embodiment following after the step S100 shown in FIG. 4;

FIG. 18 illustrates a flow chart showing operations of an embodiment of the dongle device shown in FIG. 1, where the firmware of an electronic device is updated through a wireless updating method;

FIG. 19 illustrates a flow chart showing operations of an embodiment following after the step S90 shown in FIG. 9; and

FIG. 20 illustrates a flow chart showing operations of an embodiment of the dongle device shown in FIG. 1, where the firmware of an electronic device is updated through a wired updating method.

### DETAILED DESCRIPTION

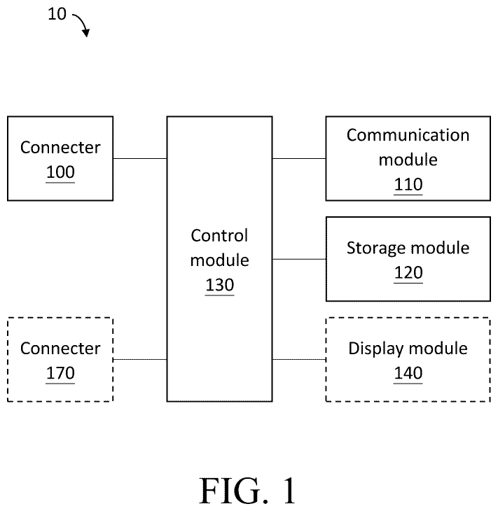

Please refer to FIG. 1. A dongle device 10 is adapted to update a firmware of an electronic device 20. The dongle device 10 includes a connector 100, a communication module 110, a storage module 120, and a control module 130. In some embodiments, the control module 130 is electrically connected to the connector 100, the communication module 110, and the storage module 120. In some embodiments, the dongle device 10 further includes a display module 140, and the display module 140 is electrically connected to the control module 130.

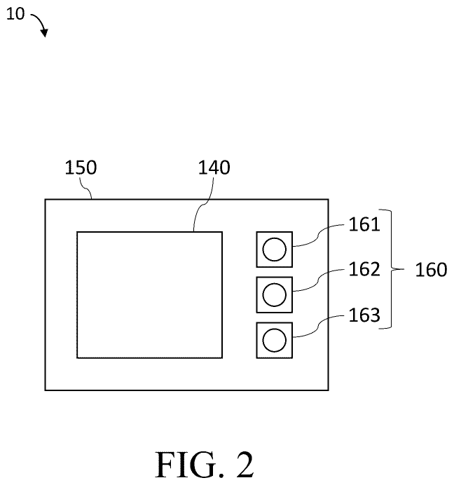

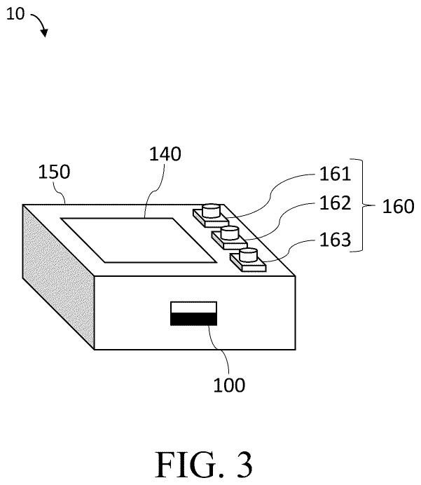

Please refer to FIG. 1 to FIG. 3. In some embodiments, the dongle device 10 further includes a housing 150 and at least one button 160. In some embodiments, the connector 100, the display module 140, and the at least one button 160 are embedded on the housing 150 (as shown in FIG. 2 and FIG. 3), and the communication module 110, the storage module 120, and the control module 130 are disposed in the housing 150 (not shown).

In some embodiments, the display module 140 and the at least one button 160 may be embedded on the front surface of the housing 150 (as shown in FIG. 2), and the connector 100 may be embedded on the side surface of the housing 150 (as shown in FIG. 3). In some other embodiments, alternatively, the display module 140 and the at least one button 160 may be embedded on the side surface of the housing 150, and the connector 100 may be embedded on the front surface of the housing 150 (not shown). In some embodiments, the at least one button 160 includes a plurality of buttons 161-163. In some embodiments, the plurality of buttons 161-163 may all be embedded on the front surface of the housing 150 (as shown in FIG. 2 and FIG. 3) or may all be embedded on the side surface (not shown). In some other embodiments, some buttons 160 are embedded on the front surface of the housing 150 and the other buttons 160 are embedded on the side surface of the housing 150 (not shown).

In some embodiments, the dongle device 10 is booted in response to a boot trigger event of the at least one button 160 through the control module 130. In some embodiments, the boot trigger event may be a long press operation, such as but not limited to an operation that presses for more than 3 seconds. Take the button 161 as an example, when the button 161 of the dongle device 10 is pressed for more than 3 seconds, the dongle device 10 is booted.

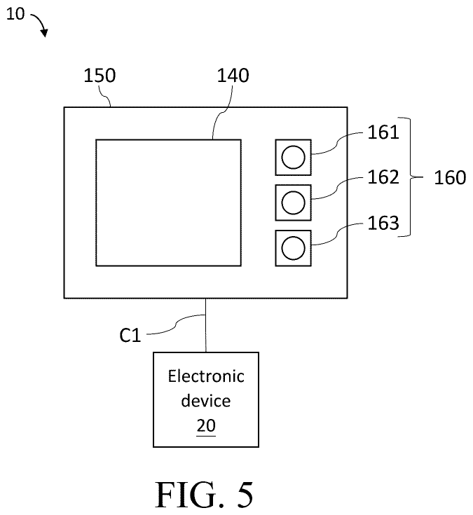

Please refer to FIG. 1 to FIG. 5. When the dongle device 10 starts updating the firmware of the electronic device 20, A wired connection C1 is established between the dongle device 10 and the electronic device 20 through the connector 100 (the step S100).

In some embodiments, the connector 100 may be an interface socket, such as but not limited to a USB socket (as shown in FIG. 3), a Micro-USB socket, a USB Type-C socket, or a Lightning socket. In some embodiments, the wired connection C1 may be a transmission cable corresponding to the connector 100 (hereinafter, referred to as the first transmission cable), one of two terminals of the first transmission cable may be plugged in the connector 100 of the dongle device 10, and the other terminal of the first transmission cable may be plugged in the electronic device 20.

In some other embodiments, the connector 100 may be an interface plug, such as but not limited to a USB plug, a Micro-USB plug, a USB Type-C plug, or a Lightning plug. In some embodiments, the dongle device 10 is plugged in a corresponding socket of the electronic device through the interface plug (not shown).

In some embodiments, the electronic device 20 may be a consumer electronics product which has a wireless communication function, such as but not limited to Bluetooth earbuds, a handheld gaming console, a handheld controller, a tablet computer, a smartphone, or a smart TV. In some embodiments, the electronic device 20 needs to install or update a corresponding firmware to operate normally.

After the step S100, the control module 130 of the dongle device 10 outputs an updating command to the electronic device 20 via the wired connection C1 (the step S110). In some embodiments, the updating command has a device ID of the dongle device 10, and the device ID is stored in the storage module 120. In some embodiments, the device ID may be at least one selected from the group consisting of a manufacturer ID of the dongle device 10, a product ID of the dongle device 10, a product name of the dongle device 10, and a product model of the dongle device 10, while the present disclosure is not limited thereto. In other words, according to some embodiments, a user can identify a corresponding dongle device 10 through the device ID.

After the step S110, the control module 130 scans and wirelessly receives a broadcast packet broadcasted by the electronic device 20 through the communication module 110 (the step S120), and the control module 130 controls the communication module 110 to establish a wireless connection between the dongle device 10 and the electronic device 20 according to the broadcast packet (the step S130), where the updating command and the broadcast packet have the same device ID. In some embodiments, when the dongle device 10 outputs the updating command to the electronic device 20 via the wired connection C1, the electronic device 20 is booted according to the updating command to receive the device ID of the dongle device 10. Then, the electronic device 20 generates the broadcast packet with the device ID and broadcasts the broadcast packet.

In some embodiments, the communication module 110 may be a Wi-Fi chip, a Bluetooth chip, or a two-in-one chip with both Wi-Fi and Bluetooth functions, while the present disclosure is not limited thereto. In some embodiments, the wireless connection is a channel between the communication module 110 and the electronic device 20 (not shown), such as but not limited to a Wi-Fi channel or a Bluetooth channel.

After the step S130, the control module 130 uses a first image file to update a firmware of the electronic device 20 via the wireless connection (the step S140). In some embodiments, the first image file is an updating program of the firmware of the electronic device 20, and the first image file is stored in the storage module 120 of the dongle device 10. In some embodiments, the storage module 120 may be a hardware component which is capable of performing reading, writing, and storing functions, such as but not limited to a non-volatile memory or a flash memory.

In some embodiments, since the dongle device 10 can establish the wired connection C1 with only one electronic device 20 at a time, the user can ensure that the dongle device 10 outputs the updating command to the correct electronic device 20. Moreover, when the dongle device 10 receives a broadcast packet broadcasted by the electronic device 20, the dongle device may further ensure whether the wireless connection between the dongle device 10 and the correct electronic device 20 is established according to the device ID in the broadcast packet.

In some embodiments, in response to an updating trigger event for one of the at least one button 160 of the dongle device 10, the control module 130 outputs the updating command to the electronic device 20 via the wired connection C1. In some embodiments, the updating trigger event may be a short press operation, such as but not limited to a single press or an operation that presses within 1 second and releases. Take the button 162 as an example, when the button 162 of the dongle device 10 is pressed once, the dongle device 10 outputs the updating command to the electronic device 20 via the wired connection C1.

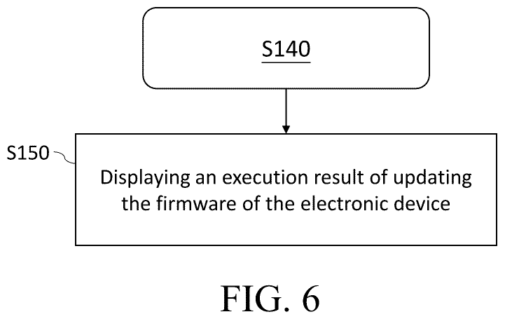

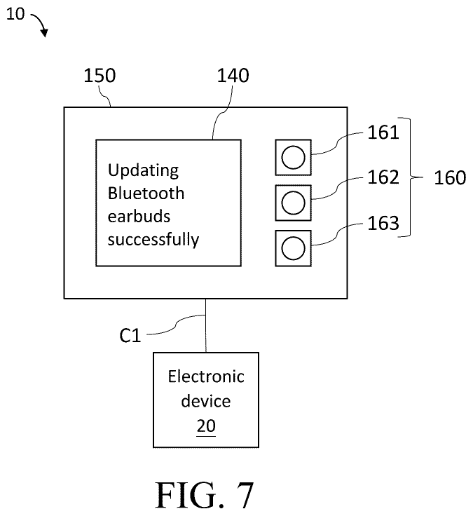

Please refer to FIG. 1 to FIG. 7. In some embodiments, after the step S140, the dongle device 10 displays an execution result of updating the firmware of the electronic device 20 through the display module 140 (the step S150). In some embodiments, the display module 140 may be a hardware component which has a display function, such as but not limited to an LCD display panel, an LED display panel, or an LED indicator light. Take the display module 140 being an LCD display panel and the electronic device 20 being Bluetooth earbuds as an example, when the execution result of updating the firmware of the electronic device 20 through the dongle device 10 is successful, the display module 140 displays “Updated Bluetooth earbuds successfully” to indicate that the update of the firmware of the electronic device 20 is successful (as shown in FIG. 7). On the other hand, when the execution result of updating the firmware of the electronic device 20 through the dongle device 10 is failed, the display module 140 displays “Failed to update Bluetooth earbuds” to indicate that the updated of the firmware of the electronic device 20 is failed (not shown).

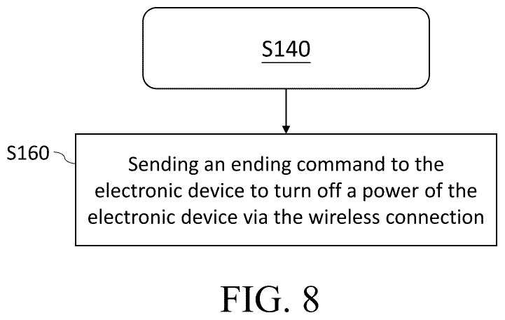

Please refer to FIG. 1 to FIG. 5 and FIG. 8. In some embodiments, after the step S140, the dongle device 10 sends an ending command to the electronic device 20 to turn off the power of the electronic device 20 via the wireless connection (the step S160). In other words, when the update of the firmware of the electronic device 20 is finished, the user may turn off the power of the electronic device 20 through the dongle device 10 to prevent the electronic device from continuously consuming standby power after the firmware is updated.

In some embodiments, in response to an ending trigger event for one of the at least one button 160 of the dongle device 10, the control module 130 outputs the ending command to the electronic device 20 via the wireless connection. In some embodiments, the ending trigger event may be a short press operation, such as but not limited to a single press or an operation that presses within 1 second and releases. Take the button 163 as an example, when the button 163 of the dongle device 10 is pressed once, the dongle device 10 outputs the ending command to the electronic device 20 via the wireless connection to turn off the power of the electronic device 20.

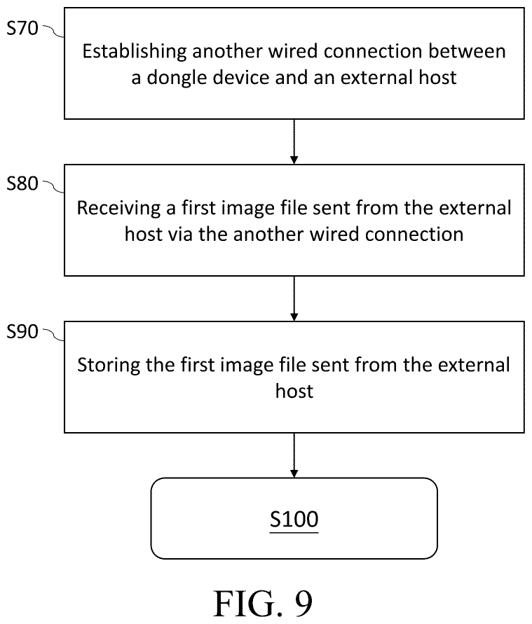

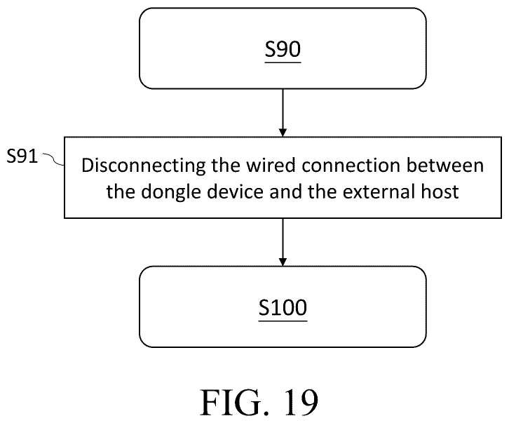

In some embodiments, when the first image file corresponding to the firmware of the electronic device 20 is not stored in the storage module 120, the user needs to receive the first image file from an external host 30 and store the first image file in advance. Please refer to FIG. 1 to FIG. 4, FIG. 9, and FIG. 19. In some embodiments, before the step S100, another wired connection C2 between the dongle device 10 and an external host 30 is established (the step S70). Then, the control module 130 receives the first image file sent from the external host 30 via the another wired connection C2 (the step S80). Last, the control module 130 stores the first image file in the storage module 120 (the step S90).

In some embodiments, the external host 30 may be a device which has an internet connection function, such as but not limited to a desktop computer, a laptop computer, a server computer, a smartphone, or a tablet computer. In some embodiments, the first image file may be stored in the external host 30 in advance, so that the external host 30 can directly transmit the first image file to the dongle device 10. In some other embodiments, even if the first image file is not stored in the external host 30, the external host 30 can download the first image file from a cloud database, a remote server, or a data center through the internet connection function, and the external host 30 transmits the first image file to the dongle device 10.

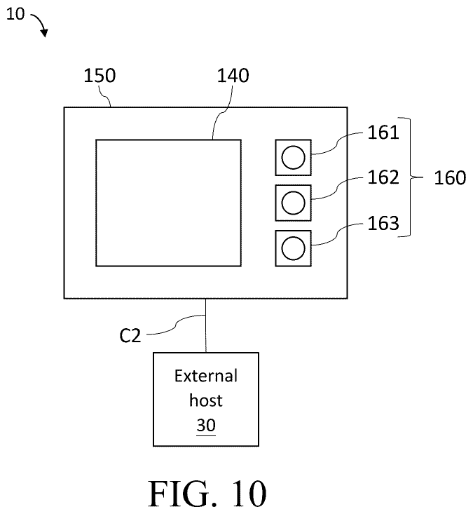

In some embodiments, the another wired connection C2 between the dongle device 10 and the external host 30 is established through the connector 100 (as shown in FIG. 3 and FIG. 10), and the control module 130 receives the first image file through the connector 100. In other words, in some embodiments, the wired connection C2 between the dongle device 10 and the external host 30 is established through the connector 100, the dongle device 10 receives the first image file sent from the external host 30 via the another connection C2, and the dongle device stores the first image file in the storage module 120. Then, the wired connection C2 between the dongle device 10 and the external host 30 is disconnected; instead, the wired connection C1 between the dongle device 10 and the electronic device 20 is established, and the dongle device provides the updating command with the device ID of the dongle device 10 for the electronic device 20 via the wired connection C1 so as to trigger a firmware updating process of the electronic device 20.

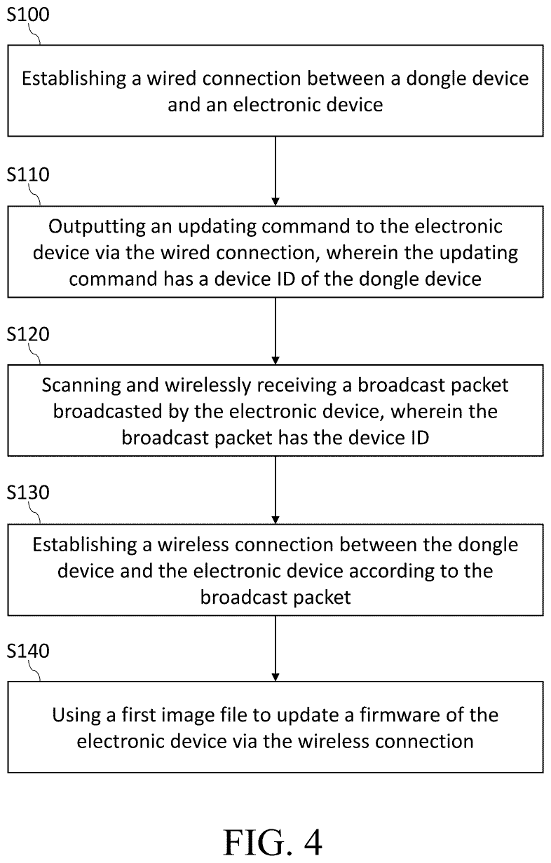

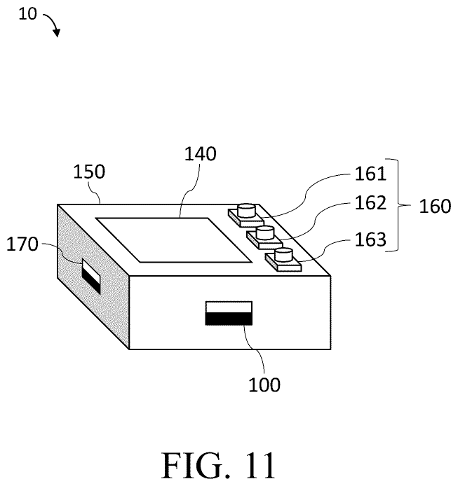

Please refer to FIG. 1, FIG. 4, and FIG. 11 to FIG. 14. In some embodiments, the dongle device 10 further comprises another connector 170, and the another connector 170 is configured to establish the another wired connection C2 between the dongle device 10 and the external host 30. In some embodiments, the control module 130 receives the first image file through the another connector 170. In other words, in some embodiments, the dongle device 10 has a plurality of connectors 100, 170. In these embodiments, the dongle device 10 can be respectively connected to the electronic device 20 through the connector 100 and to the external host 30 through the connector 170 at the same time. In some other embodiments, the dongle device 10 can be connected to the external host 30 through the connector 170 to obtain the first image file and then can be connected to the electronic device 20 through the connector 100 to send the updating command to the electronic device 20.

In some embodiments, the another connector 170 may be an interface socket, such as but not limited to a USB socket (as shown in FIG. 11), a Micro-USB socket, a USB Type-C socket, or a Lightning socket. In some embodiments, the wired connection C2 may be another transmission cable corresponding to the another connector 170 (hereinafter referred to as a second transmission cable), one of two terminals of the second transmission cable may be plugged in the connector 170 of the dongle device 10, and the other terminal of the second transmission cable may be plugged in the external host 30.

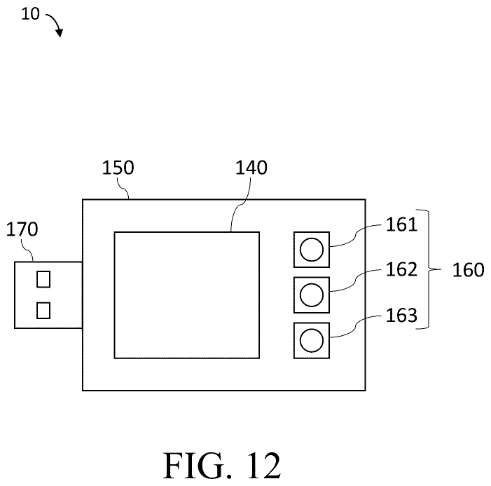

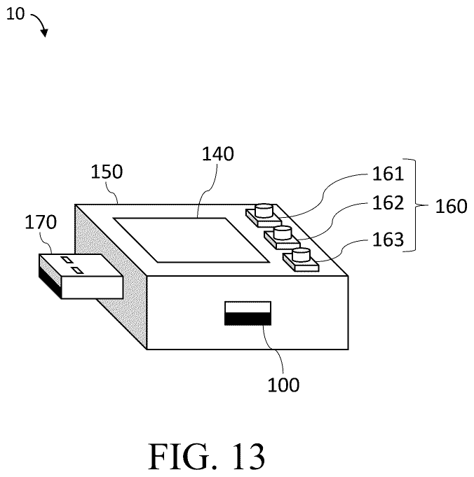

In some other embodiments, the another connector 170 may be an interface plug, such as but not limited to a USB plug (as shown in FIG. 12 and FIG. 13), a Micro-USB plug, a USB Type-C plug, or a Lightning plug. In some embodiments, the dongle device 10 is plugged in a corresponding socket of the external host 30 through the interface plug (not shown).

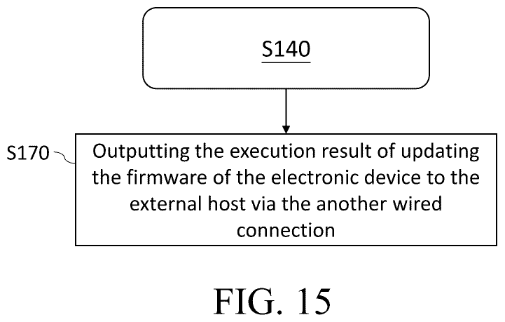

Please refer to FIG. 1 to FIG. 5 and FIG. 9 to FIG. 15. In some embodiments, after the step S140, the control module 130 is further configured to output the execution result of updating the firmware of the electronic device 20 to the external host 30 via the another wired connection C2 (the step S170). Take the external host 30 being a laptop computer and the electronic device 20 being Bluetooth earbuds as an example, when the execution result of updating the firmware of the electronic device 20 through the dongle device 10 is successful, a display of the external host 30 displays “Updated Bluetooth earbuds successfully” to indicate that the update of the firmware of the electronic device 20 is successful. On the other hand, when the execution result of updating the firmware of the electronic device 20 through the dongle device 10 is failed, the display of the external host 30 displays “Failed to update Bluetooth earbuds” to indicate that the update of the firmware of the electronic device 20 is failed (not shown).

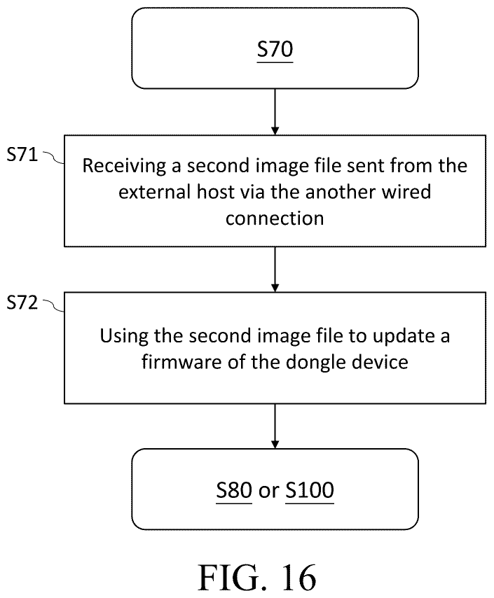

Please refer to FIG. 1 to FIG. 5, FIG. 9 to FIG. 14, and FIG. 16. In some embodiments, after the step S70, the dongle device 10 receives a second image file sent from the external host via the another wired connection C2 (the step S71), and the dongle device 10 uses the second image file to update the firmware of the dongle device 10 (the step S72). In some embodiments, the second image file is an updating program for the firmware of the dongle device 10. In some embodiments, the dongle device 10 needs to install a corresponding firmware to operate normally. Therefore, in some embodiments, the external host 30 can store the second image file in advance, so that the external host 30 can directly transmit the second image file to the dongle device 10, and thus the dongle device 10 can use the second image file to update the firmware of the dongle device 10. In some other embodiments, even if the second image file is not stored in the external host 30, the external host 30 can download the second image file from a cloud database, a remote server, or a data center through the internet connection function, and the external host 30 transmits the second image file to the dongle device 10.

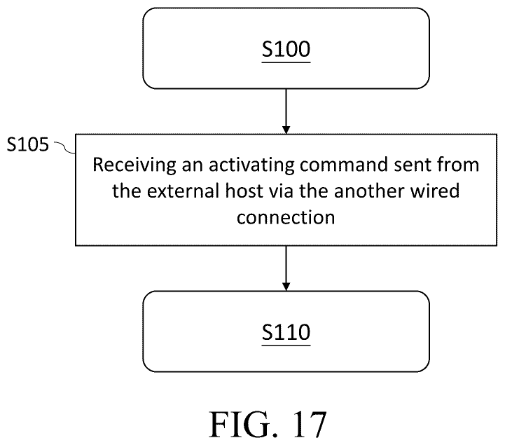

Please refer to FIG. 1, FIG. 2, and FIG. 17. In some embodiments, after the step S100, the dongle device 10 receives an activating command sent from the external host 30 via the another wired connection C2 (the step S105). In some embodiments, the step of outputting the updating command (the step S110) is executed in response to the activating command. In some embodiments, when the wired connection C1 between the dongle device 10 and the electronic device 20 and the another wired connection C2 between the dongle device 10 and the external host 30 are established at the same time, the user can generate the activating command through the external host 30 to control the dongle device 10 to output the updating command to the electronic device 20.

In some embodiments, the dongle device 10 can update the firmware of the electronic device 20 in the manner of offline updating or online updating. In some embodiments, “offline updating” refers to that the wired connection C1 between the dongle device 10 and the electronic device 20 and the another wired connection C2 between the dongle device 10 and the external host 30 are not established at the same time when the dongle device 10 updates the firmware of the electronic device 20. On the contrary, “online updating” refers to that the wired connection C1 between the dongle device 10 and the electronic device 20 and the another wired connection C2 between the dongle device 10 and the external host 30 are established at the same time when the dongle device 10 updates the firmware of the electronic device 20.

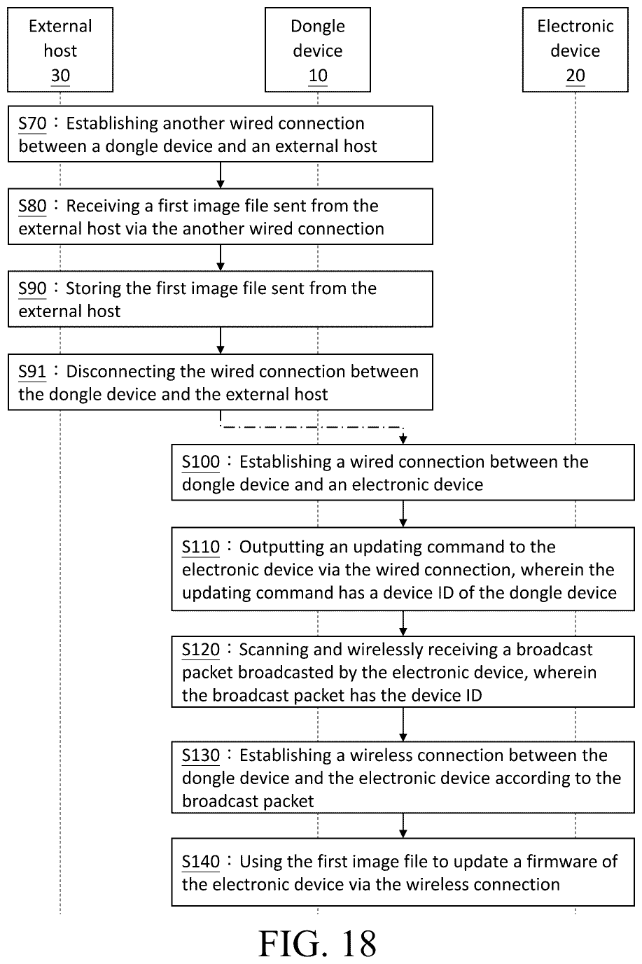

Please refer to FIG. 1 to FIG. 5, FIG. 9, FIG. 10, FIG. 18, and FIG. 19. In some embodiments, when the dongle device 10 updates the firmware of the electronic device 20 in the manner of offline updating, the another wired connection C2 between the dongle device 10 and the external host 30 is established to receive and store the first image file (the steps S70-S90). In this embodiment, after the dongle device 10 receives and stores the first image file, the wired connection C2 between the dongle device 10 and the external host 30 is disconnected (the step S91, as shown in FIG. 18 and FIG. 19) before the wired connection C1 between the dongle device 10 and the electronic device 20 is established to update the firmware of the electronic device 20 (the steps S100-S140). It should be understood that, in some embodiments, the steps S100-S140 shown in FIG. 18 can be executed after a period of time after the step S91. For example, the user can download the first image file corresponding to the electronic device from the external host 30 to the dongle device 10 in advance (the steps S70-S91). At this moment, the first image file is stored in the dongle device 10. When the firmware of the electronic device 20 needs to be updated, the user then updates the firmware of the electronic device 20 through the first image file stored in the dongle device 10 (the steps S100-S140).

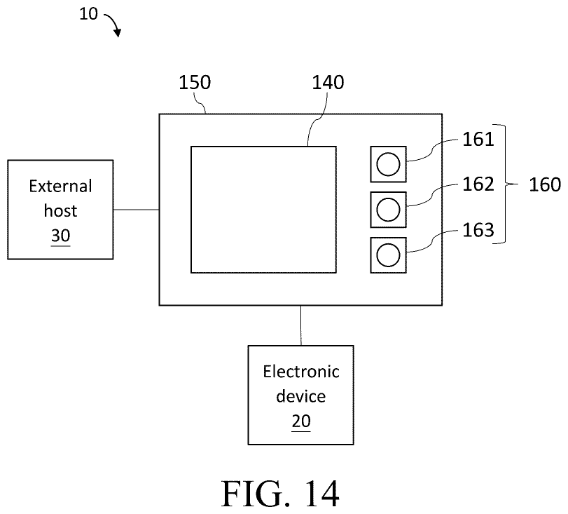

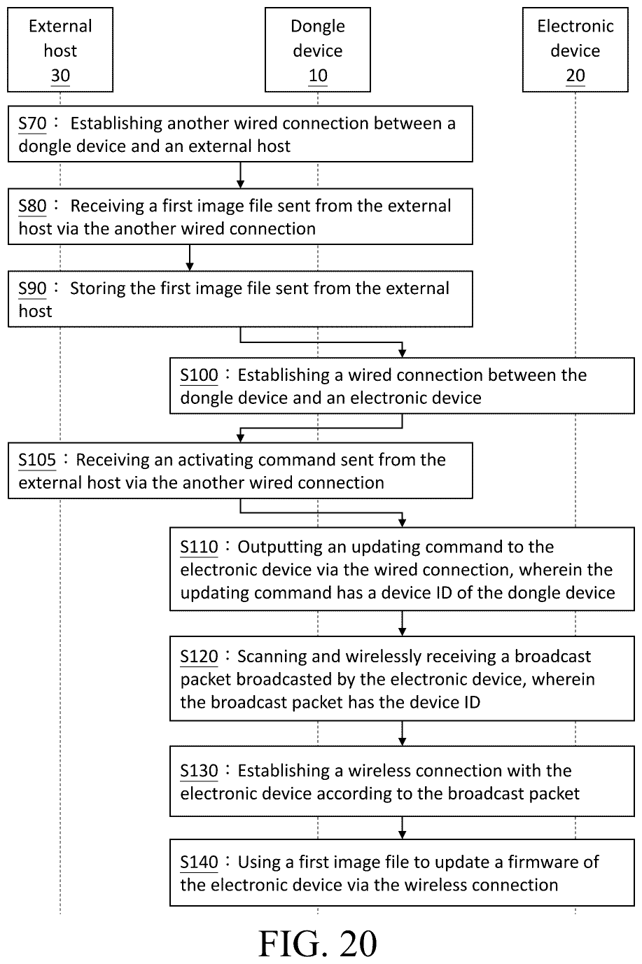

Please refer to FIG. 1, FIG. 9, FIG. 11 to FIG. 14, and FIG. 20. In some embodiments, when the dongle device 10 updates the firmware of the electronic device 20 in the manner of online updating, the another wired connection C2 between the dongle device 10 an external host 30 is established to receive and store the first image file (the steps S70-S90). In the present embodiment, after the dongle device 10 receives and stores the first image file, the wired connection C1 between the dongle device 10 and the electronic device 20 is established (the step S100). In other words, in some embodiments, the wired connection C1 between the dongle device 10 and the electronic device 20 and the another wired connection C2 between the dongle device 10 and the external host 30 can exist at the same time (as shown in FIG. 14). After the dongle device 10 receives the activating command sent from the external host 30 via the another wired connection C2 (the step S105), the dongle device 10 starts to update the firmware of the electronic device 20 (the steps S110-S140).

In some embodiments, when the dongle device 10 updates the firmware of the electronic device 20 in the manner of offline updating, the wired connection C1 between the dongle device 10 and the electronic device 20 and the another wired connection C2 between the dongle device 10 and the external host 30 are established through a same connector, or the wired connection C1 between the dongle device 10 and the electronic device 20 and the another wired connection C2 between the dongle device 10 and the external host 30 are established through different connectors.

In this embodiment, when the wired connection C1 between the dongle device 10 and the electronic device 20 and the another wired connection C2 between the dongle device 10 and the external host 30 are established through the same connector, the another wired connection C2 between the dongle device 10 and the external host 30 is established through the connector 100 in advance (for example, two terminals of a second transmission cable are respectively plugged in the connector 100 of the dongle device 10 and the external host 30) to receive the first image file sent from the external host 30. After the dongle device 10 receives the first image file, the dongle device 10 disconnects the another wired connection C2 (for example, the second transmission cable is unplugged from the connector 100), and the wired connection C1 between the dongle device 10 and the electronic device 20 is established through the connector 100 (for example, two terminals of a first transmission cable are respectively plugged in the connector 100 of the dongle device 10 and the electronic device 20) to update the firmware of the electronic device 20. In other words, in this embodiment, the control module 130 outputs the updating command to the electronic device 20 through the connector 100 when the connector 100 is connected to the electronic device 20 (corresponding to the step S110).

In the present embodiment, when the wired connection C1 between the dongle device and the electronic device 20 and the another wired connection C2 between the dongle device and the external host 30 are established through the different connectors, the wired connection C1 between the dongle device 10 and the electronic device 20 is established through the connector 100 and the another wired connection C2 between the dongle device 10 and the external host 30 is established through the another connector 170 (for example, two terminals of a first transmission cable are respectively plugged in the connector 100 of the dongle device and the electronic device 20, and two terminals of a second transmission cable are respectively plugged in the another connector 170 of the dongle device 10 and the external host 30). In some embodiments, after the dongle device 10 receives the first image file, the user can disconnect the another wired connection C2 between the dongle device 10 and the external host (for example, the second transmission cable is unplugged from the another connector 170).

In some embodiments, when the dongle device 10 updates the firmware of the electronic device 20 in the manner of online updating, the wired connection C1 between the dongle device 10 and the electronic device 20 and the another wired connection C2 between the dongle device 10 and the external host 30 are established through different connectors. At this moment, the wired connection C1 between the dongle device 10 and the electronic device is established through the connector 100 and the another wired connection C2 between the dongle device 10 and the external host 30 is established through the another connector 170 (for example, two terminals of a first transmission cable are respectively plugged in the connector 100 of the dongle device 10 and the electronic device 20, and two terminals of a second transmission cable are respectively plugged in the another connector 170 of the dongle device and the external host 30). In other words, in this embodiment, the control module 130 receives the activating command sent from the external host 30 through the another connector 170 (corresponding to the step S105). Moreover, the control module 130 outputs the execution result of updating the firmware of the electronic device 20 to the external host 30 through the another connector 170 (corresponding to the step S170), and the control module 130 receives a second image file sent from the external host 30 through the another connector 170, and thus the dongle device 10 uses the second image file to update the firmware of the dongle device 10 (corresponding to the steps S71-S72).

In some embodiments, the dongle device 10 can achieve online updating through Over-the-air (OTA) technique to update the firmware of the electronic device 20. The OTA technique is a technique which uses a wireless internet or a telecommunications network to achieve a remote management function. In some embodiments, the OTA technique may be implemented in an internet environment, and the remote management function comprises a firmware updating function, a system debugging function, or a system reporting function, while the present disclosure is not limited thereto. In some embodiments, the OTA technique is widely applied in various types of electronics or intelligent vehicles. Take the electric vehicle “Model 3” launched by Tesla as an example (hereinafter referred to as Model 3), when a problem is occurred to the tablet computer of the Model 3, the user can connect to the online support center of Tesla through the fourth generation (4G) of mobile communication network built-in the Model 3 or a communication module (for example, a Wi-Fi chip) built-in the Model 3 to allow a support staff of Tesla to remotely perform a system debugging operation. Besides, the problem occurs to the tablet computer of Model 3 can also be reported to the online support center of Tesla for further analyzing.

In some embodiments, the control module 130 may be a hardware component which has a control function, such as but not limited to a central processing unit (CPU), a microprocessor, a digital signal processor (DSP), a complex programmable logic device (CPLD), a field programmable gate array (FPGA), an application specific integrated circuit (ASIC), or a microcontroller unit (MCU).

In some embodiments, the terms “dongle” itself may be an adaptor, a connector, or a transmitter which has a communication function, such as but not limited to an RJ45 adaptor, a universal serial bus (USB) connector, or a Bluetooth transmitter. In some other embodiments, the terms “dongle” itself may be a computer hardware device which has an operation system (OS), such as but not limited to an Android TV stick or an Apple TV stich. In some embodiments, the dongle device 10 in the present disclosure may also be regarded as a “dongle”.

In conclusion, according to one or some embodiments, a user can download the firmware image file of the electronic device from the external host to the dongle device in advance, so that the dongle device and the firmware updating method can support both the offline updating function and the online updating function. Therefore, the user can update the firmware of the electronic device through the dongle device in the manner of offline updating or online updating so as to improve the convenience of updating the firmware of the electronic device.

Although the present disclosure has been described in considerable detail with reference to certain preferred embodiments thereof, the disclosure is not for limiting the scope of the invention. Persons having ordinary skill in the art may make various modifications and changes without departing from the scope and spirit of the disclosure. Therefore, the scope of the appended claims should not be limited to the description of the preferred embodiments described above.

What is claimed is:

1. A firmware updating method adapted to a dongle device, wherein the firmware updating method comprises:
establishing a wired connection between the dongle device and an electronic device;
outputting an updating command to the electronic device via the wired connection, wherein the updating command has a device ID of the dongle device;
scanning and wirelessly receiving a broadcast packet broadcasted by the electronic device, wherein the broadcast packet has the device ID;
establishing a wireless connection between the dongle device and the electronic device according to the broadcast packet; and
using a first image file to update a firmware of the electronic device via the wireless connection, wherein the first image file is stored in a storage module of the dongle device.

2. The firmware updating method according to claim 1, further comprising:
displaying an execution result of updating the firmware of the electronic device.

3. The firmware updating method according to claim 1, further comprising:
sending an ending command to the electronic device to turn off the power of the electronic device via the wireless connection after the step of updating the firmware of the electronic device.

4. The firmware updating method according to claim 1, further comprising:
establishing another wired connection between the dongle device and an external host;
receiving the first image file sent from the external host via the another wired connection; and
storing the first image file sent from the external host.

5. The firmware updating method according to claim 4, further comprising:
receiving an activating command sent from the external host via the another wired connection after the step of receiving the first image file, wherein the step of outputting the updating command is executed in response to the activating command.

6. The firmware updating method according to claim 4, further comprising:
outputting the execution result of updating the firmware of the electronic device to the external host via the another wired connection after the step of updating the firmware of the electronic device.

7. The firmware updating method according to claim 4, further comprising:
receiving a second image file sent from the external host via the another wired connection; and
using the second image file to update a firmware of the dongle device.

8. The firmware updating method according to claim 1, wherein the step of outputting the updating command via the wired connection is executed in response to an updating trigger event of at least one button of the dongle device.

9. A dongle device comprising:
a connector;
a communication module;
a storage module configured to store a device ID and a first image file; and
a control module electrically connected to the connector, the communication module, and the storage module, wherein the control module is configured to output an updating command to an electronic device through the connector, the control module is configured to control the communication module to scan and to wirelessly receive a broadcast packet broadcasted by the electronic device, the control module is configured to control the communication module to establish a wireless connection between the dongle device and the electronic device according to the broadcast packet, and the control module is configured to use the first image file to update a firmware of the electronic device via the wireless connection, wherein the updating command and the broadcast packet have the same device ID.

10. The dongle device according to claim 9, further comprising:
a display module electrically connected to the control module, wherein the display module is configured to display an execution result of updating the firmware of the electronic device.

11. The dongle device according to claim 10, further comprises a housing and at least one button, wherein the connector, the display module, and the at least one button are embedded on the housing, the communication module, the storage module, and the control module are disposed in the housing, and the control module is further configured to boot the dongle device in response to a boot trigger event of the at least one button.

12. The dongle device according to claim 11, wherein the control module is further configured to output the updating command to the electronic device through the connector in response to an updating trigger event of the at least one button.

13. The dongle device according to claim 9, further comprising:
another connector configured to establish another wired connection between the dongle device and an external host;
wherein the control module is further configured to receive the first image file sent from the external host through the another connector and store the first image file in the storage module.

14. The dongle device according to claim 13, wherein the control module is further configured to receive an activating command sent from the external host through the another connector, and the control module outputs the updating command to the electronic device through the connector in response to the activating command.

15. The dongle device according to claim 13, wherein the control module is further configured to output the execution result of updating the firmware of the electronic device to the external host through the another connector.

16. The dongle device according to claim 13, wherein the control module is further configured to receive a second image file sent from the external host through the another connector and use the second image file to update a firmware of the dongle device.

17. The dongle device according to claim 9, wherein the connector is configured to establish a wired connection between the dongle device and the electronic device, the connector is configured to establish another wired connection between the dongle device and an external host, the control module is further configured to receive the first image file sent from the external host through the connector when the connector is connected to the external host and store the first image file in the storage module, and the control module outputs the updating command to the electronic device through the connector when the connector is connected to the electronic device.
